(19) United States
(12) Patent Application Publication
(10) Pub. No.: US 2012/0057536 A1
(43) Pub. Date: Mar. 8, 2012

(54) METHOD AND APPARATUS FOR SUPPORTING MULTI-BAND WIFI

(75) Inventors: Lochan VERMA, Seoul (KR); Dae-yong SIM, Hwaseong-si (KR); Scott Seong-wook LEE, Suwon-si (KR)

(73) Assignee: SAMSUNG ELECTRONICS CO., LTD., Suwon-si (KR)

(21) Appl. No.: 13/210,844

(22) Filed: Aug. 16, 2011

Related U.S. Application Data
(60) Provisional application No. 61/379,493, filed on Sep. 2, 2010.

(30) Foreign Application Priority Data
Nov. 2, 2010 (KR) 10-2010-0108388

(51) Int. Cl. H04W 72/04; H04W 84/02

(52) U.S. Cl. 370/329; 370/338

(57) ABSTRACT

Provided are a method and apparatus for supporting a multiband wireless fidelity (WiFi). The method for supporting the multiband WIFI includes: assigning a category and a frequency band for traffic, based on one or more characteristics of the traffic; packetizing the traffic in a media access control (MAC) unit corresponding to the assigned frequency band; and transmitting the packetized traffic by using the assigned frequency band in a physical layer (PHY) unit corresponding to the assigned frequency band.

### CROSS-REFERENCE TO RELATED PATENT APPLICATIONS

This application claims the benefit of U.S. Provisional Patent Application No. 61/379,493, filed on Sep. 2, 2010, and claims priority from Korean Patent Application No. 10-2010-0108388, filed on Nov. 2, 2010 in the Korean Intellectual Property Office, the disclosures of which are incorporated herein in their entireties by reference.

### BACKGROUND

1. Field

Apparatuses and methods consistent with exemplary embodiments relate to wireless communication, and more particularly, to a multiband wireless fidelity (WiFi) device including a traffic sorting unit for assigning categories and frequency bands that are appropriate for traffic characteristics, at least one media access control (MAC) unit and at least one physical layer (PHY) unit, for supporting different frequency bands and simultaneously transmitting traffic, and a method of supporting a multiband WiFi.

2. Description of the Related Art

Recently, application services of transmitting various multimedia data at high speed have been widely used in wireless communication fields. In addition, the potential market for consumer electronic (CE) devices with these services has grown.

Based on the extent of this potential market growth, since the Institute of Electrical and Electronics Engineers (IEEE) 802.11 working group (WG) established the 802.11b standard for supporting a transmission speed of a maximum of 11 Mbps by using a frequency band of 2.4 GHz, and disseminated wireless local area network (WLAN) technologies to markets, WLAN technologies have been continuously developed according to 802.11n (2.4 GHz/5 GHz, and 600 Mbps) through 802.11a (5 GHz, and 54 Mbps) and 802.11g (2.4 GHz, and 54 Mbps) standards. Specifically, the 802.11n standard uses a plurality of antennas, and applies multiple-input multiple-output (MIMO) technologies for widening bandwidths in proportion to the number of antennas.

Recently, wireless high definition (WiHD) using millimeter wave (mmWave) technologies of a bandwidth of 60 GHz for supporting a physical layer (PHY) data rate of several gigabits per second (Gbps), and next generation WLAN technologies using high frequency bandwidths such as very high frequency (VHF)/ultra high frequency (UHF) have been suggested.

The trademark “WiFi” may be used for an authenticated device obeying a WiFi alliance 802.11 standard.

### SUMMARY

One or more aspects of exemplary embodiments provide a multiband wireless fidelity (WiFi) device including a traffic sorting unit for assigning categories and frequency bands that are appropriate for traffic characteristics, at least one media access control (MAC) unit and at least one physical layer (PHY) unit, for supporting different frequency band and simultaneously transmitting traffic, a method of supporting a multiband WiFi, and a computer readable recording medium having recorded thereon a program for executing the method.

According to an aspect of an exemplary embodiment, there is provided a method of supporting multiband wireless fidelity (WiFi), the method including: assigning a category, from among a plurality of assignable categories, and a frequency band, from among a plurality of assignable frequency bands, for traffic, based on one or more characteristics of the traffic; packetizing the traffic in a media access control (MAC) unit corresponding to the assigned frequency band; and transmitting the packetized traffic by using the assigned frequency band in a physical layer (PHY) unit corresponding to the assigned frequency band.

The MAC unit and the PHY unit may be a single MAC unit and a single PHY unit supporting the assigned frequency band, from among at least one MAC unit and at least one PHY unit.

The at least one MAC unit may include first and second MAC units supporting different frequency bands, and first and second PHY units supporting different frequency bands.

The categories may include at least one of a real-time traffic type and a non real-time traffic type, a long range traffic type and a short range traffic type, a high throughput traffic type and an average throughput traffic type, and a background (BK) type, a best effort (BE) type, a video (V) type or a voice (VO) type.

The frequency bands may include at least one of 2.4 GHz, 5 GHz, 60 GHz, a very high frequency (VHF), and an ultra high frequency (UHF).

The assigning the category and the frequency band for respective traffic may be performed by setting at least one flag.

The method may further include generating the traffic in an application unit.

The packetizing the traffic may be simultaneously performed by a plurality of MAC units and the transmitting the packetized traffic may be simultaneously performed a plurality of PHY units.

According to an aspect of another exemplary embodiment, there is provided a computer readable recording medium having recorded thereon a program for executing the method.

According to an aspect of another exemplary embodiment, there is provided a multiband wireless fidelity (WiFi) device including: a traffic sorting unit which assigns a category and a frequency band for traffic, based on one or more characteristics of the traffic; a MAC unit which packetizes the traffic, and corresponds to the assigned frequency band; and a PHY unit which transmits the packetized traffic by using the assigned frequency band, and corresponds to the assigned frequency band.

According to an aspect of another exemplary embodiment, there is provided a method of supporting multiband wireless fidelity (WiFi), the method including: assigning a frequency band, from among a plurality of assignable frequency bands, for traffic, based on one or more characteristics of the traffic; packetizing the traffic in a MAC unit corresponding to the assigned frequency band; and transmitting the packetized traffic by using the assigned frequency band in a PHY unit corresponding to the assigned frequency band.

### BRIEF DESCRIPTION OF THE DRAWINGS

The above and other features and advantages will become more apparent by describing in detail exemplary embodiments with reference to the attached drawings in which:

FIG. 1 is a conceptual view of a spatial multiplexing (SM) technique of a 802.11n device, according to an exemplary embodiment;

FIG. 2 is a conceptual view of a Space Time Block Coding (STBC) technique of a 802.11n device, according to an exemplary embodiment;

FIG. 3 is a conceptual view of forming a beam in a 802.11n system, according to an exemplary embodiment;

FIG. 4 is a conceptual view of a multiband wireless fidelity (WiFi) network, according to an exemplary embodiment;

FIG. 5 is a structural view of a multiband WiFi device, according to an exemplary embodiment;

FIG. 6 is a structural view of multi-media access control (MAC) multi-physical layer (PHY) (MMMP), according to an exemplary embodiment;

FIG. 7 is a structural view of multi-MAC single-PHY (MMSP) according to another exemplary embodiment;

FIG. 8 is a structural view of single-MAC multi-PHY, according to an exemplary embodiment;

FIG. 9 is a table for comparing different multiband WiFi devices in terms of designs;

FIG. 10 shows user scenarios of the multiband WiFi device, according to an exemplary embodiment; and

FIG. 11 is a flowchart of a method of providing multiband WiFi, according to an exemplary embodiment.

### DETAILED DESCRIPTION OF EXEMPLARY EMBODIMENTS

Exemplary embodiments will now be described more fully with reference to the accompanying drawings, in which like reference numerals in denote like elements, and the thicknesses of layers and regions are exaggerated for clarity. Furthermore, it is understood that expressions such as “at least one of,” when preceding a list of elements, modify the entire list of elements and do not modify the individual elements of the list.

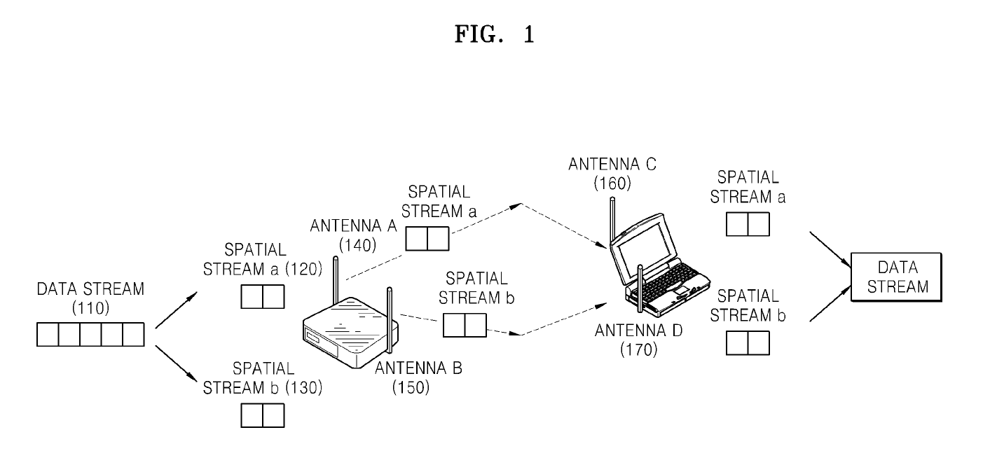

FIG. 1 is a conceptual view of a spatial multiplexing (SM) technique of a 802.11n device, according to an exemplary embodiment.

In the SM technology, a data stream 110 is divided into a plurality of pieces of spatial streams 120 and 130, and the spatial streams 120 and 130 are independently transmitted using any of a plurality of sender antennas 140 and 150 and received using any of a plurality of receiver antennas 160 and 170. That is, the SM technology multiplexes a space dimension. As the number of spatial streams is increased, a data rate maybe increased.

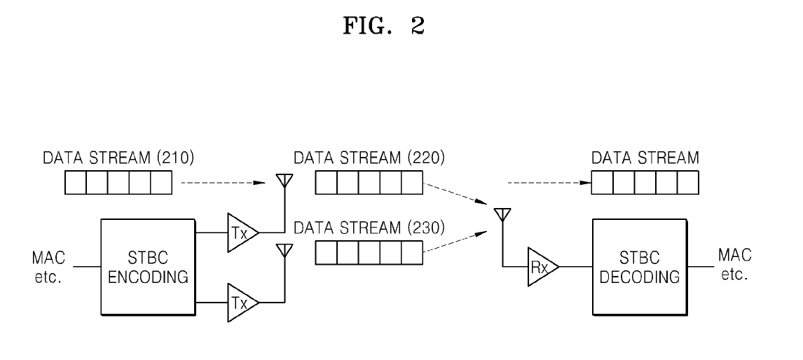

FIG. 2 is a conceptual view of a Space Time Block Coding (STBC) technique of a 802.11n device, according to an exemplary embodiment.

The STBC technique uses an antenna diversity method with a plurality of sender antennas, regardless of the number of receiver antennas. The STBC technique may improve a signal to noise ratio (SNR) in a receiver device by transmitting the same data stream 210, 220, and 230 a plurality of times by using the antenna diversity technique, thereby improving a data ratio.

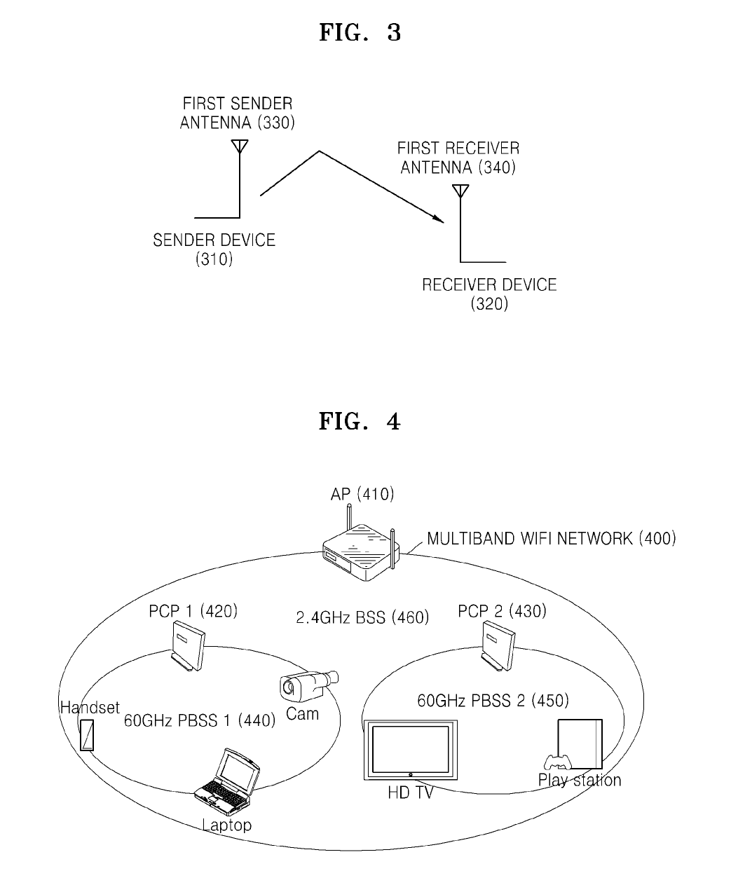

FIG. 3 is a conceptual view of forming a beam in a 802.11n system, according to an exemplary embodiment.

The 802.11n device supports a beam formation technology that is one of smart antenna methods. The beam formation technology is a method of embodying an antenna whose beam receives signals from a desired direction or transmits signals to a desired direction.

In FIG. 3, a sender device 310 of the 802.11n system forms a beam of a first sender antenna 330 so as to reduce interference with ambient signals and to then transmit signals to a receiver device 320, and the receiver device 320 forms a beam of a first receiver antenna 340 so as to minimize interference with ambient signals and to then receive signals from the sender device 310.

The sender device 310 may physically point to the receiver device 320 by using at least one directional antenna in order to compensate for a free space loss and increase efficiency of an antenna.

FIG. 4 is a conceptual view of a multiband wireless fidelity (WiFi) network 400, according to an exemplary embodiment.

The multiband WiFi network 400 is a wireless local area network (WLAN) including a multiband WiFi for supporting a multiband. The WLAN may be managed by an access point (AP) 410.

The multiband WiFi network 400 may include a plurality of WiFi personal area networks (WPANs), and the WPANs may be defined as personal basic service sets (PBSSs) 440 and 450, respectively. The PBSSs 440 and 450 may conceptually correspond to a basic service set (BSS) 460 of a WLAN. The PBSSs 440 and 450 are managed by personal control points (PCPs) 420 and 430, respectively. The PCPs 420 and 430 correspond to the AP of the WLAN, conceptually. A multiband WiFi device may be included in a single PBSS, and simultaneously may be included in a BSS.

In FIG. 4, the multiband WiFi device includes a multiband WiFi chip set for supporting 2.4 GHz, 5 GHz, and 60 GHz. A 802.11b standard uses a frequency of 2.4 GHz, and supports a transmission speed of 11 Mbps. A 802.11a standard uses a frequency band of 5 GHz, and supports a transmission speed of 54 Mbps. A 802.11g standard uses a frequency band of 2.4 GHz, and supports a transmission speed of 54 Mbps. A 802.11n standard uses frequency bands of 2.4 GHz and 5 GHz, and supports a transmission speed of 600 Mbps. Since a wireless high definition (WiHD) standard may support a transmission speed of several gigabits (Gbps) by using a millimeter Wave (mmWave) of a frequency band of 60 GHz, the WiHD may be used to transmit non-compression high definition television (HDTV) signals.

Although not illustrated, a multiband WiFi chip set of a multiband WiFi device may support a high frequency band such as very high frequency (VHF) or ultra high frequency (UHF). In addition to the high frequency band, the multiband WiFi chip set of the multiband WiFi device may support various other frequency bands.

In FIG. 4, the multiband WiFi network 400 includes two PBSSs 440 and 450. The PBSS 1 440 and the PBSS 2 450 may be managed by the PCP 1 420 and the PCP 2 430, respectively. The multiband WiFi device in the PBSS 440 and 450 may also be included in the BSS 460 managed by the AP 410.

In FIG. 4, a laptop computer represents the multiband WiFi device and may transmit and receive HDTV traffic by using a camcorder as another multiband WiFi device in the PBSS 1 440 and a peer-to-peer link by using a frequency band of 60 GHz. Simultaneously, the laptop computer may transmit and receive File Transfer Protocol (FTP) traffic or e-mail traffic to the Internet through the AP 410 managing the BSS 460 by using a frequency band of 2.4 GHz, and may transmit and receive traffic to and from another multiband WiFi device in the BSS 460.

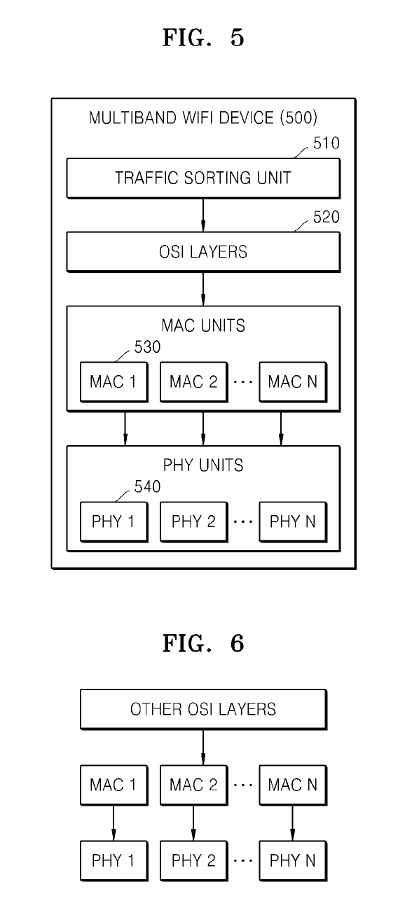

FIG. 5 is a structural view of a multiband WiFi device 500, according to an exemplary embodiment.

The multiband WiFi device 500 includes a traffic sorting unit 510, the Open Systems Interconnection (OSI) layers 520, a media access control (MAC) unit 530, and a physical layer (PHY) unit 540. The traffic sorting unit 510 assigns each category and each frequency band for respective traffic, based on characteristics of the traffic. Categories based on the traffic characteristics may include at least one of a real-time traffic type, a non real-time traffic type, a long range traffic type, a short range traffic type, a high throughput traffic type, an average throughput traffic type, a background (BK) type, a best effort (BE) type, a video (V) type, and a voice (VO) type, which are suggested by the 802.11e standard.

The traffic sorting unit 510 assigns a MAC unit and a PHY unit, which are appropriate for traffic characteristics, from among at least one MAC unit and at least one PHY unit, based on categories according to characteristics of traffic.

The traffic sorting unit 510 assigns categories and frequency bandwidths by setting flags. The traffic sorting unit 510 transmits the set flag to the MAC unit 530 through the OSI layers 520 that are lower layers of the OSI layer model.

For example, the traffic sorting unit 510 may transmit high bandwidth HDTV traffic by using a frequency band of 60 GHz, and may transmit relatively low bandwidth e-mail traffic by using a frequency band of 2.4 GHz, in corresponding MAC and PHY layers, by assigning the high throughput traffic type and a frequency band of 60 GHz to the HDTV traffic, and assigning the average throughput traffic type and a frequency band of 2.4 GHz to the e-mail traffic.

The MAC unit 530 refers to a single MAC unit for supporting an assigned frequency band from among at least one MAC unit. The at least one MAC unit may support each respective different frequency band. The at least one MAC unit is a MAC unit corresponding to each respective different frequency band, and may simultaneously packetize traffic.

The PHY unit 540 refers to a single PHY unit for supporting an assigned frequency band from among at least one PHY unit. The at least one PHY unit may support each respective different frequency band. The at least one PHY unit is a PHY unit corresponding to each respective different frequency band, and may simultaneously transmit the packetized traffic.

For example, frequency bands for supporting the MAC unit 530 and the PHY unit 540 may each be one of VHF and UHF.

The multiband WiFi device 500 may further include at least one application unit (not shown), and each application unit may generate traffic having predetermined characteristics.

The multiband WiFi device 500 may include a plurality of antennas that may operate according to the same frequency, as illustrated in FIGS. 1 through 3, or may include a plurality of antennas that may operate according to different frequencies. Thus, in the multiband WiFi device 500, MAC and PHY units that support a frequency appropriate for sorted traffic may be selected, and traffic may be transmitted to the selected MAC and PHY units by sorting traffic according to application traffic characteristics by using the traffic sorting unit 510, thereby improving frequency usage and application performance.

In addition, the multiband WiFi device 500 may simultaneously transmit a plurality of pieces of data by using a plurality of MAC units and a plurality of PHY units for supporting different frequencies in a single device.

According to an exemplary embodiment, since multiband WiFi devices in a multiband WiFi network may transmit data with different frequencies at a predetermined point of time, interference between signals may be minimized.

FIG. 6 is a structural view of multi-MAC multi-PHY (MMMP), according to an exemplary embodiment.

The multiband WiFi device 500 includes MAC units and PHY units that are independently dedicated to respective frequency bands.

For example, MAC/PHY units 1, MAC/PHY units 2, and MAC/PHY units N may support frequency bands corresponding to 2.4 GHz, 5 GHz and 60 GHz, respectively.

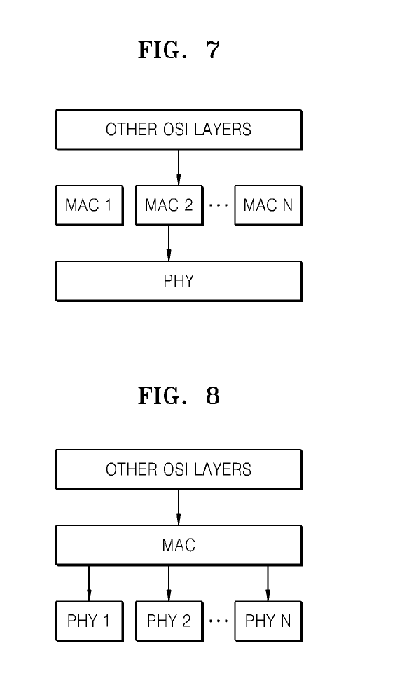

FIG. 7 is a structural view of multi-MAC single-PHY (MMSP) according to another exemplary embodiment.

According to the present exemplary embodiment, the multiband WiFi device 500 may include MAC units that are independently dedicated to respective frequency bands, and a single PHY unit for supporting all different frequency bands.

FIG. 8 is a structural view of single-MAC multi-PHY, according to an exemplary embodiment.

According to the present exemplary embodiment, the multiband WiFi device 500 may include a single MAC unit for supporting all different frequency bands, and PHY units that are independently dedicated to respective frequency bands.

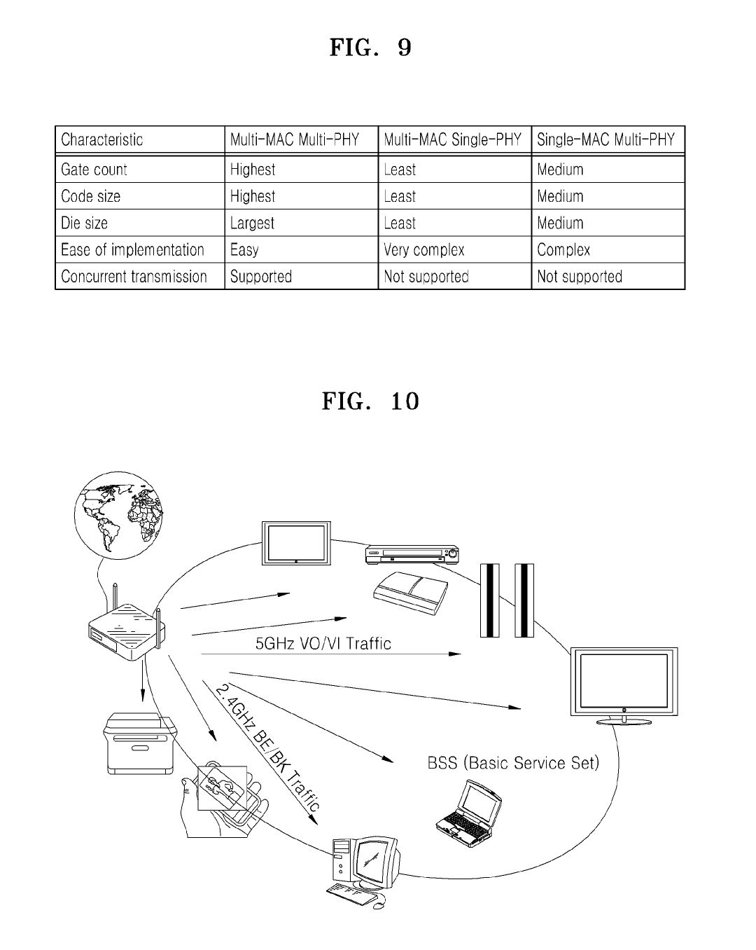

FIG. 9 is a table for comparing different multiband WiFi devices in terms of designs.

In the exemplary case illustrated in FIG. 9, even though it is simplest to embody the MMMP structure, since the MMMP structure includes MAC units and PHY units that are independently dedicated to respective frequency bands, the highest costs may be incurred. The MMMP structure has the greatest number of gates, the greatest number of codes, and the largest size of die. In addition, since the MMMP structure includes MAC units and PHY units that are independently dedicated to respective frequency bands, the MMMP structure may simultaneously transmit data.

Since the MMSP structure includes a single PHY unit for supporting all frequency bands, it may be complicated to embody the MMSP structure. Since the number of gates of a general PHY unit is eight times as many as the number of gates of a general MAC unit, the MMSP structure has the smaller numbers of gates and codes, and the smaller size of die compared to those of the SMMP structure.

Since the SMMP structure includes a single MAC unit provided by combining a plurality of MAC units, the SMMP structure has the smaller numbers of gates and codes, and the smaller size of die compared to those of the MMMP structure.

The MMSP structure and the SNMP structure may not simultaneously transmit data.

FIG. 10 shows user scenarios of the multiband WiFi device 500, according to an exemplary embodiment.

In FIG. 10, the traffic sorting unit 510 of the multiband WiFi device 500 assigns the VO traffic type and a frequency band of 5 GHz, and the VI traffic type and a frequency band of 5 GHz to voice traffic and video traffic, respectively, and thus a MAC unit and a PHY unit that correspond to a frequency band of 5 GHz may transmit the voice traffic and the video traffic.

The traffic sorting unit 510 of the multiband WiFi device 500 assigns the BE traffic type, the BK traffic type and a frequency band of 2.4 GHz to optimum service traffic such as e-mail, and thus a MAC unit and a PHY unit that correspond to a frequency band of 2.4 GHz may transmit the optimum service traffic.

The multiband WiFi device 500 may simultaneously transmit the optimum service traffic by using a frequency band of 2.4 GHz while transmitting voice/video traffic by a plurality of MAC units and a plurality of PHY units by using a frequency band of 5 GHz.

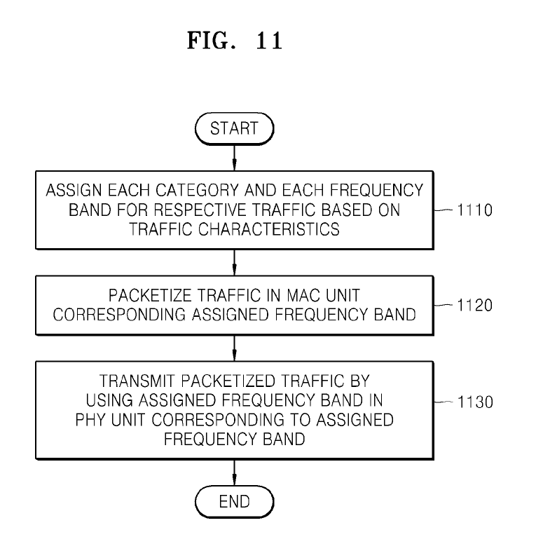

FIG. 11 is a flowchart of a method of providing multiband WiFi, according to an exemplary embodiment.

In operation 1110, the traffic sorting unit 510 of the multiband WiFi device 500 assigns categories and frequency bandwidths for respective traffic, based on traffic characteristics.

The category may include at least one of a real-time traffic type, a non real-time traffic type, a long range traffic type, a short range traffic type, a high throughput traffic type, an average throughput traffic type, a BK type, a BE type, a V type and a VO type, which are suggested by the 802.11e standard.

A frequency band may be any one of 2.4 GHz, 5 GHz, 60 GHz, VHF, and UHF.

The multiband WiFi device 500 assigns category and frequency bandwidths by setting flags.

Traffic is generated by an application unit that exists in an upper layer of the traffic sorting unit 510.

In operation 1120, a MAC unit of the multiband WiFi device 500, which corresponds to an assigned frequency band, packetizes traffic. The MAC unit refers to a single MAC unit for supporting an assigned frequency band from among at least one MAC unit. The at least one MAC unit may support each respective different frequency band.

In operation 1130, a PHY unit of the multiband WiFi device 500, which corresponds to an assigned frequency band, transmits the packetized traffic by using the assigned frequency band. The PHY unit refers to a single PHY unit for supporting an assigned frequency band from among at least one PHY unit. The at least one PHY unit may support each respective different frequency band.

The packetizing of traffic in operation 1120, and the transmitting of the packetized traffic in operation 1130 may be simultaneously performed by the at least one MAC unit and the at least one PHY unit.

For example, the multiband WiFi device 500 may include a bus coupled to each unit of the multiband WiFi device 500, and at least one processor coupled to the bus, and may include a memory that is coupled to the bus in order to store received messages or generated messages, and is coupled to at least one processor in order to perform the above-described instructions.

One or more exemplary embodiments can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Moreover, one or more of the above-described units can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the present inventive concept as defined by the following claims.

What is claimed is:

1. A method of supporting multiband wireless fidelity (WiFi), the method comprising:
assigning a category, from among a plurality of assignable categories, and a frequency band, from among a plurality of assignable frequency bands, for traffic, based on one or more characteristics of the traffic;
packetizing the traffic in a media access control (MAC) unit corresponding to the assigned frequency band; and
transmitting the packetized traffic by using the assigned frequency band in a physical layer (PHY) unit corresponding to the assigned frequency band.

2. The method of claim 1, wherein the MAC unit is a single MAC unit supporting the assigned frequency band, from among at least one MAC unit, and the PHY unit is a single PHY unit supporting the assigned frequency band, from among and at least one PHY unit.

3. The method of claim 2, wherein:
the at least one MAC unit comprises a first MAC unit corresponding to a first frequency band and a second MAC unit corresponding to a second frequency band, different than the first frequency band; and
the at least one PHY unit comprises a first PHY unit corresponding to the first frequency band and a second PHY unit corresponding to the second frequency band.

4. The method of claim 1, wherein the plurality of assignable categories comprises at least one of:
a real-time traffic type and a non real-time traffic type;
a long range traffic type and a short range traffic type;
a high throughput traffic type and an average throughput traffic type; and
a background (BK) type, a best effort (BE) type, a video (V) type and a voice (VO) type.

5. The method of claim 1, wherein the plurality of assignable frequency bands comprises at least one of 2.4 GHz, 5 GHz, 60 GHz, a very high frequency (VHF), and an ultra high frequency (UHF).

6. The method of claim 1, wherein the assigning the category and the frequency band for the traffic is performed by setting at least one flag.

7. The method of claim 1, further comprising generating the traffic in an application unit.

8. The method of claim 3, wherein the first MAC unit and the second MAC unit simultaneously packetize respective traffic and the first PHY unit and the second PHY unit simultaneously transmit the respective packetized traffic.

9. The method of claim 2, wherein:
the at least one MAC unit comprises a first MAC unit corresponding to a first frequency band and a second MAC unit corresponding to a second frequency band, different than the first frequency band; and
the at least one PHY unit comprises the single PHY unit which supports the plurality of assignable frequency bands.

10. The method of claim 2, wherein:
the at least one MAC unit comprises the single MAC unit which supports the plurality of assignable frequency bands; and
the at least one PHY unit comprises a first PHY unit corresponding to a first frequency band and a second PHY unit corresponding to a second frequency band, different than the first frequency band.

11. A multiband wireless fidelity (WiFi) device comprising:
a traffic sorting unit which assigns a category, from among a plurality of assignable categories, and a frequency band, from among a plurality of assignable frequency bands, for traffic based on one or more characteristics of the traffic;
a MAC unit, corresponding to the assigned frequency band, which packetizes the traffic; and
a PHY unit, corresponding to the assigned frequency band, which transmits the packetized traffic by using the assigned frequency band.

12. The multiband WiFi device of claim 11, wherein the MAC unit is a single MAC unit supporting the assigned frequency band, from among at least one MAC unit, and the PHY unit is a single PHY unit supporting the assigned frequency band, from among at least one PHY unit.

13. The multiband WiFi device of claim 12, wherein:
the at least one MAC unit comprises a first MAC unit corresponding to a first frequency band and a second MAC unit corresponding to a second frequency band, different than the first frequency band; and
the at least one PHY unit comprises a first PHY unit corresponding to the first frequency band and a second PHY unit corresponding to the second frequency band.

14. The multiband WiFi device of claim 11, wherein the plurality of assignable categories comprises at least one of:
a real-time traffic type and a non real-time traffic type;
a long range traffic type and a short range traffic type;
a high throughput traffic type and an average throughput traffic type; and
a background (BK) type, a best effort (BE) type, a video (V) type and a voice (VO) type.

15. The multiband WiFi device of claim 11, wherein the plurality of assignable frequency bands comprises at least one of 2.4 GHz, 5 GHz, 60 GHz, a very high frequency (VHF), and an ultra high frequency (UHF).

16. The multiband WiFi device of claim 11, wherein the traffic sorting unit assigns the category and the frequency band by setting at least one flag.

17. The multiband WiFi device of claim 11, further comprising an application unit which generates the traffic.

18. The multiband WiFi device of claim 13, wherein:
the first MAC unit and the second MAC unit simultaneously packetize respective traffic; and
the first PHY unit and the second PHY unit simultaneously transmit the respective packetized traffic.

19. A method of supporting multiband wireless fidelity (WiFi), the method comprising:
assigning a frequency band, from among a plurality of assignable frequency bands, for traffic, based on one or more characteristics of the traffic;
packetizing the traffic in a media access control (MAC) unit corresponding to the assigned frequency band; and
transmitting the packetized traffic by using the assigned frequency band in a physical layer (PHY) unit corresponding to the assigned frequency band.

20. A computer readable recording medium having recorded thereon a program for executing the method of claim 1.

21. A computer readable recording medium having recorded thereon a program for executing the method of claim 19.
